(19) United States
(12) Patent Application Publication
(10) Pub. No.: US 2005/0172261 A1
(43) Pub. Date: Aug. 4, 2005

(54) Architecture for creating a user interface using a data schema

(76) Inventors: Paul J. Yuknewicz, Redmond, WA (US); Antoine Cote, Redmond, WA (US); Sean Conway Draine, Seattle, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/768,497

(22) Filed: Jan. 30, 2004

(51) Int. Cl. G06F 9/44

(52) U.S. Cl. 717/106; 717/136

(57) ABSTRACT

A rich user interface (UI) development framework that uses the schema of a data source to which it is relevant. The developer is able to rapidly create a data bound UI using a number of familiar gestures, including drag and drop, from the schema in a data tool window, using a designer tasks, or using a data form creation wizard. The system includes a UI generation component that allows a developer to input a number of different controls into the interface using associated control graphics. A data source object, type, or file can be passed to the UI generation component as an input. The developer chooses the desired controls and associates (or binds) the data entity of the data source with the control by any number of gestures.

### TECHNICAL FIELD

This invention is related to software development tools, and more specifically, a tool for generating a user interface.

### BACKGROUND OF THE INVENTION

Software vendors are continually advancing the latest in development tools for users to take advantage of software being pushed to consumers. Typically, such tools require some level of familiarity by developer with the tool(s) language and structure in order to use the development tool(s) and develop the appropriate interface. However, the rapid evolution in which such development frameworks are manufactured and sold impact the speed with which such tools can be understood and used to provide the software for which they are created. Developers are still left spending an inordinate amount of time learning and struggling with the development environment in order to provide a suitable product for a customer.

What is needed is an improved development framework.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention disclosed and claimed herein, in one aspect thereof, comprises a system of designer software that facilitates the creation of a rich user interface (UI) using a schema of a data source to which it is relevant. The developer is able to rapidly create a data bound UI using a number of familiar gestures, including drag and drop, from the schema in a data tool window, using a designer task, or using a data form creation wizard. The system includes a UI generation component that allows a developer to input a number of different controls into the interface using associated control graphics. A data source object, type, or file can be passed to the UI generation component as an input. The developer chooses the desired controls and associates (or binds) the data entity of the data source with the control by any number of gestures. For example, the developer can drag-and-drop the data entity onto the control graphic. The schema of the data source can be obtained from the data source, or inferred using mechanisms such as reflection, for example. The UI generation framework allows the developer to specify exactly what UI to create for a given schema element through the use of UICreatorInput objects that are attached to parts of the schema.

In another aspect thereof, the tool facilitates allowing the developer to bind the data source to an existing UI by dragging and dropping fields from the data source schema onto an existing control (this gesture called “connect the dots data binding”). Using the schema of a data source to drive this feature is particularly useful because it allows the design environment to enable a consistent set of UI generation operations using the schema metadata, even if the data sources have proprietary object definitions and implementations. For example, this allows the developer to perform UI generation for heterogeneous objects, including but not limited to, database tables, database stored procedures, objects (e.g., business objects), and web service return results.

In another aspect of the present invention, the tool provides a developer with a simple and rapid approach to create a new UI using only a portion of the data schema.

In another aspect of the present invention, the tool provides a developer with a simple and rapid approach to bind existing UI and existing sources of data using a data schema.

In another aspect of the present invention, the tool enables a developer to have a consistent set of UI generation features using heterogeneous sources or types of data.

In another aspect of the present invention, the tool provides a powerful and flexible framework for creating multiple UI views over a data schema.

In another aspect of the present invention, the tool provides a powerful and flexible framework for creating a UI view over a data schema using custom control preferences.

In another aspect of the present invention, the tool provides extensibility points for future design time gestures, designer tasks, and wizards that create UI views over data. The UI generation framework is extensible to allow for future UI views, UI controls, and UI designer platforms.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 illustrates a block diagram of a system of the present invention.

FIG. 2 illustrates a flow chart of a process of the present invention.

FIG. 3 illustrates a flow block diagram of the system of the present invention.

FIG. 4 illustrates a flow chart of a process of the present invention in accordance with FIG. 3.

FIG. 5 illustrates a flow chart of a process for merging schema in accordance with the present invention.

FIG. 6 illustrates an alternate system implementation of the present invention that includes an inference component.

FIG. 7 illustrates a system of the present invention where the structure of the UI defines the structure of the data source.

FIG. 8 illustrates a sample tool development environment screenshot for selecting sample UI controls via a configuration wizard.

FIG. 9 illustrates a tool development environment screenshot after the database objects have been moved to the explorer windows.

FIG. 10 illustrates a tool development environment screenshot of a data schema form used for associating data source objects.

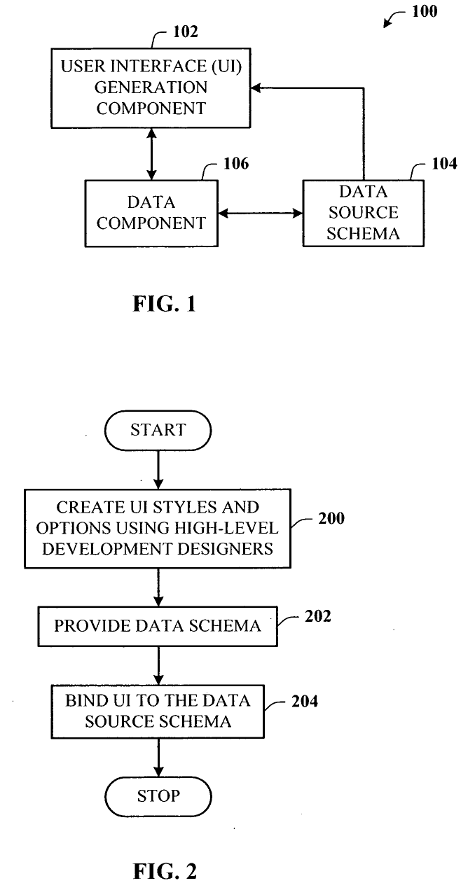

FIG. 1I illustrates a tool development environment screenshot of the controls that are generated for use with the data source objects.

FIG. 12 illustrates a block diagram of a computer operable to execute the disclosed architecture.

FIG. 13 illustrates a schematic block diagram of an exemplary computing environment in accordance with the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Referring now to FIG. 1, there is illustrated a block diagram of a system 100 of the present invention. The present invention takes the approach of generating a user interface (UI) from (as a function of) schema and other metadata, no matter what the heterogeneous data source may be. This is made possible by first extrapolating schema from a particular datasource, e.g., a database, object, or web service result. Therefore, there is an opportunity to easily extend the domain of data sources and the range of UI outputs in the future.

The present invention comprises the system (or development tool) 100 of designer software that facilitates the creation of a rich UI using a schema of a data source to which it is relevant. The developer is able to rapidly create a data bound UI using a number of familiar gestures (including, for example, a drag-and-drop gesture) from the schema in a data tool window, using a designer task, or using a data form creation wizard.

In support thereof, the system 100 includes a UI generation component 102 for generating and applying controls and related objects during creation of the UI. The UI generation component 102 allows a developer to input a number of different controls into the interface being developed using associated control graphics. The system 100 also includes a data source schema component 104 in communication with the UI component 102 that includes schema information related to a data source. A data source object, type, or file can be passed to the UI generation component 102 as an input. Note that the data source schema 104 can reside at a database server or any other data source. A data component 106 in communication with the UI component 102 and the data source schema 104 facilitates binding the data source schema 104 to the UI controls of the UI generation component 102. The data component 106 can also be included as part of the functionality of the UI generation component 102.

In operation, the developer chooses the desired controls and associates (or binds) the data entity of the data source with the control by any number of gestures. For example, the developer can drag-and-drop the data entity onto the control graphic. The schema 104 of the data source can be obtained from the data source, or inferred using mechanisms such as reflection, for example. The UI generation system 100 allows the developer to specify exactly what UI to create for a given schema element with, e.g., UICreatorInput objects that are attached to parts of the schema 104.

The system facilitates allowing the developer to bind the data source schema 104 to an existing UI by dragging and dropping fields from the data source schema onto an existing control (this gesture called “connect the dots data binding”). Using the data source schema 104 of a data source to drive this feature is particularly useful because it allows the design environment to enable a consistent set of UI generation operations using the schema metadata, even if the data sources have proprietary object definitions and implementations. For example, this allows the developer to perform UI generation for heterogeneous objects, including but not limited to, database tables, database stored procedures, objects, and web service return results.

The system 100 also provides a developer with a simple and rapid approach to create a new UI using only a portion of the data schema 104. The system 100 also provides the developer with a simple and rapid approach to bind existing UI and existing sources of data using a data schema 104. Moreover, the system 100 enables the developer to have a consistent set of UI generation features using heterogeneous sources or types of data. The system 100 also provides a powerful and flexible framework for creating multiple UI views over the data schema 104, and for creating a UI view over a data schema using custom control preferences.

In another aspect of the present invention, the system 100 also provides extensibility points for future design time gestures, designer tasks, and wizards that create UI views over data. The UI generation framework is extensible to allow for future UI views, UI controls, and UI designer platforms.

The tool facilitates building an application for many different purposes. For example, the developer might use the invention to build a graphical UI application that enables customers to visualize, browse, navigate, and modify data from the datasource (order entry form, business intelligence tool). Moreover, the disclosed architecture can be used to build a fully functional application by itself through simple, standard user interface gestures of the sort with which ordinary computer users would be familiar. The invention could also be used in combination with extensibility points that allow more advanced customizations of application behavior through techniques such as writing code.

Referring now to FIG. 2, there is illustrated a flow chart of a process of the present invention. While, for purposes of simplicity of explanation, the one or more methodologies shown herein, e.g., in the form of a flow chart, are shown and described as a series of acts, it is to be understood and appreciated that the present invention is not limited by the order of acts, as some acts may, in accordance with the present invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

The development system of the present invention provides high-level development support for a developer so that the developer can develop an application in a much more expedient manner than conventional development architectures. For example, using a drag-and-drop gesture, the user/developer can easily apply a control to a form and, easily and quickly align, size the control properly, and bind data to the control, to name just a few of the expedient operations.

At 200, the developer creates UI styles and options using high-level development designer tools. At 202, the data schema of the data source is provided for binding with the UI or elements thereof that have been created. Note that the data binding can occur as each UI control is created and placed on the UI. Data binding can also occur after the complete UI has been created. At 204, the developer use system (or tool) to bind the data to the UI. Again, this need not occur as a single step, but can occur as multiple steps during UI generation.

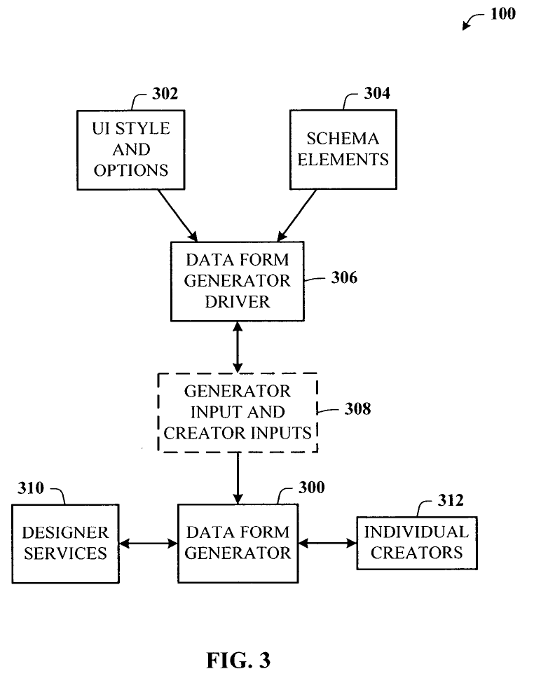

Referring now to FIG. 3, there is illustrated a flow block diagram of the system 100 of the present invention. At the core of the system is a data form generator 300 that receives inputs, and outputs the resulting UI for the given data source. A UI style and options component 302 includes default, as well as custom styles and controls for use in creating the UI. In the data sources window of the development tool 100, the developer can select for a specific column and what kind of UI desired. The tool will also present a list of controls that can be used, e.g., a DateTime Picker. Schema elements 304 include different types of sources (e.g., a database, and web services), data source elements with properties, and which properties have a name and type.

A dataform generator driver 306 receives as inputs the UI styles and options 302, and the schema elements 304. The generator driver 306 is a piece of software that looks at the schema elements 304 and attempts to apply the UI styles and options 302. For example, there exists a list of the schema elements 304 for which the user wants a grid, or details. The generator driver 306 systematically walks through all the fields if the data source schema elements 304 and attempts to associate the best control type with the schema element with the control type. In other words, the generator driver 306 creates a possible mapping table between the given schema elements 304 and the UI controls and options 302 provided by the developer. This is also to say that the possible mapping is not applied at this time.

A generator input and creator input component 308 receives the output of the generator driver 306. The input component 308 also receives style choices from developer (or creator). For example, within the data source schema 304, there may be two related elements (e.g., customers and orders). The developer can indicate through one or more selections that these are what are used to create the master-details. An input will then point to these two elements and create a master details with those two elements. The generator input includes additional information that might be needed, e.g., at what location the developer wants to start generating the UI, and other things similar types of information. The inputs component 306 communicates bi-directionally with the generator driver 306, since the inputs received at the inputs component 308 can be fed back thereto to facilitate the possible mappings of the controls and the schema elements. Note that the inputs component 308 is indicated as an optional separate component, since its functions can be combined with, for example, the data form generator driver 306 or data form generator 300.

A designer services component 310 interfaces to the data for generator 300 and provides functions for use during the development process such as an undo/redo function. For example, if something goes wrong when the UI is being generated (e.g., an exception is thrown by one of the creators), the tool can undo it in accordance with this selected function (i.e., a rollback process) as provided by the designer services component 310. Of course, other similar functions can be selected for use by the developer during the UI-generation process.

The data form generator 300 creates the controls, but once created, the controls utilized become a collection of controls that are added to the form being generated, e.g., the user controls. The data form generator 300 scans for all inputs, and generates a master-details list that is used to invoke the appropriate creator software for creating the various aspects of the UI. Individual creators 312 interface to the data form generator 300, and are handlers that are invoked for specific purposes depending on the creator input and outputs.

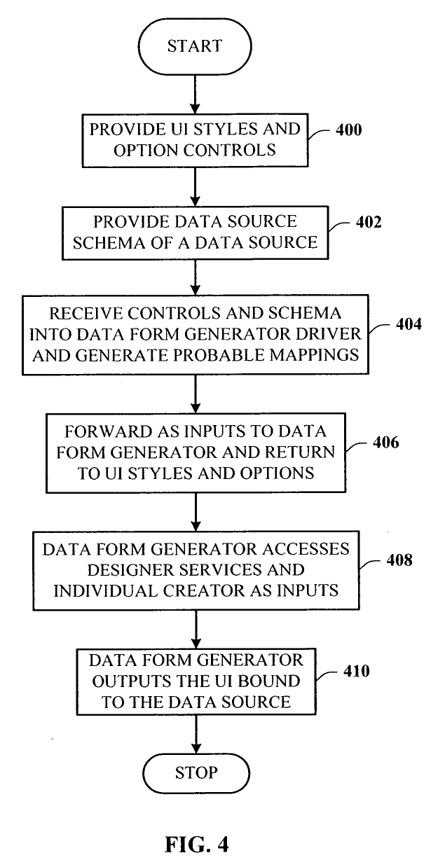

Referring now to FIG. 4, there is illustrated a flow chart of a process of the present invention in accordance with FIG. 3. At 400, the developer provides UI styles and options. This can be on a piecemeal basis, and need not be such that all controls and options are selected at one time. At 402, the data source schema is provided. The developer uses the tool to select the data source, and then to peruse the data source for the tables and other entities used therein. At 404, the controls and schema information are input into the generator driver to determine the probable mappings between the UI controls and data source schema that could be used. At 406, the probable mappings information is passed to one or both of the UI style and options where the developer can review and further refine the probable mappings, and the inputs generator, where the developer can resolve any conflicts that may have been presented. At 408, the data form generator receives the resolved mappings information, and accesses the designer services to utilize other development controls and functions in furtherance of completing the UI generation. At 410, the data form generator accesses the individual creators handlers to finalize processing of the UI by binding the data source to the UI controls. The process then reaches a Stop block. Note that the generator is not limited to the creation of UI elements, but can also create non-visual components and spit the code required for the data form to work properly. Those components can be, for example, responsible for retrieving/updating data from/to a specific data source (e.g., database and a web service). An example of the code could be a handler for a button event so that when the button is clicked by the user, the appropriate call to the data component is made.

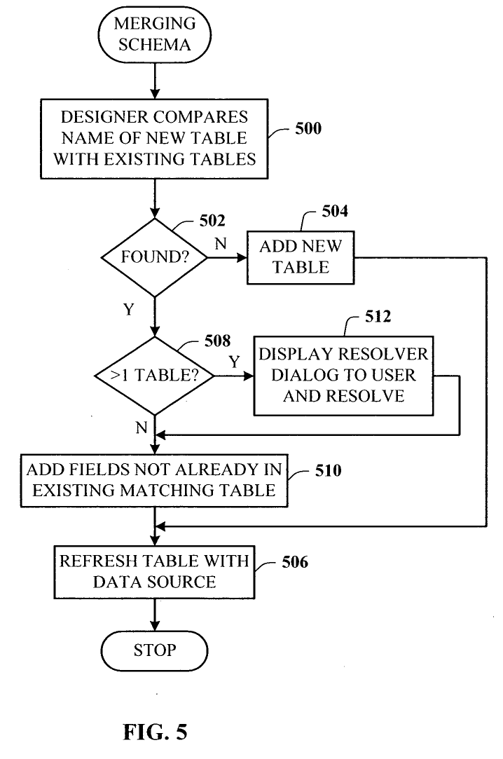

Referring now to FIG. 5, there is illustrated a flow chart of a process for merging schema in accordance with the present invention. At 500, a tool designer compares the name of a new source table with the data source names of existing tables already listed in the designer. The name comparison is against original, pre-mapped table names. To speed up performance, the designer should cache source table names whenever queries are configured, rather than attempting to reparse the query every time. If no match is found, at 502, the new table is added, as indicated at 504. Note that the tool is also able to compare schemas at more granular levels. For example, it can detect that there is an additional column in the source schema and merge that specific column with the schema in the application. At 506, the table is then refreshed with the data source, and the process reaches a Stop block. However, at 502, if a match is found, and there are not multiple instances of tables having the same names, as indicated at 508, any field(s) not already in the existing table are added, at 510. At 506, the metadata of any existing fields are then refreshed with those in the database (e.g., data type, constraints, and auto-increment). However, user-defined captions on the fields are preserved. In some cases, the designer may contain more than one table querying a given source table in the database. If the designer finds more than one table match, at 508, a resolver dialog is displayed to the user to determine which table the new data should be merged, as indicated at 512. Flow is then to the input of 510 to apply the fields, as before. Note that a designer table can have a master query, and possibly one or more data functions associated with it. These queries may in turn call stored procedures (sprocs) or dynamic SQL queries. Schema merges are automatically applied to all dynamic SQL queries associated with the table.

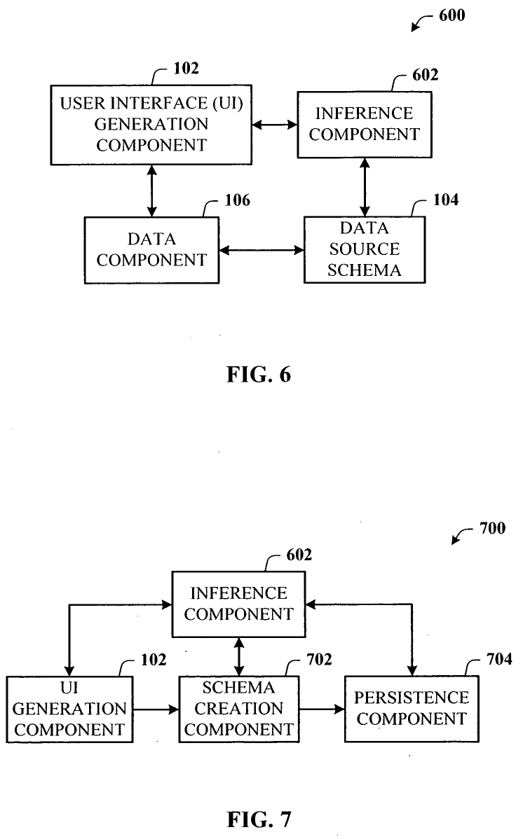

Referring now to FIG. 6, there is illustrated an alternate system implementation 600 of the present invention that includes an inference component 602. As indicated herein, the data schema can also be associated with the UI controls and options after the controls and options have all been determined. The developer can simply drag-and-drop the data source schema identity on an existing control, and perceive that the data schema is then bound to the control by a change in the state of a graphical indicia, e.g., a mouse cursor icon. The developer can alter an existing binding (i.e., unbind, and then rebind to a different control), and receive feedback when the new binding is confirmed.

There at least two versions of binding: automatic binding, where by making a user gesture on the forms template (e.g., drag-and-drop) the tool makes a decision as to what display object the data schema entity is associated with; and late binding, where the user creates the UI first, display control objects are positioned and looking as desired, and then the user simply associates the data fields with the corresponding UI controls, and the tool binds the control to the data entity on the fly, such that the control-data associations are performed after the fact.

In another implementation, the UI is generated based upon the type of platform on which the UI will be used. Consider that there are at last four main platform types: a desktop computer, a laptop or portable computer, a portable computing device (e.g., a PDA—Personal Digital Assistant) and web services. In this particular implementation, the development tool is provided to prompt the developer for the platform on which the UI will be used. The tool can also determine the target platform automatically by using information like the project type and flavor (e.g., win, web, and mobile device), and current design surface (e.g., form and component). Accordingly, the tool will then draw from a library of default forms and default controls that facilitate the implementation of the UI on the selected platform. The user can also override and/or supplement the default selections. Moreover, the tool can be configured to further provide default layouts of the controls on the forms such that when viewed on the platform, the UI is perceived and interacted with by the user conveniently and productively. Thus, the tool may provide a lesser number of controls for a given UI that will be presented on the display of a small portable handheld device, and a larger number of controls for a UI of a larger display of a desktop computer.

Depending on the intended platform on which the UI is to be employed, the tool can be configured to not only bring forth a set of forms of the given platform, but to bring the set of forms in a preferential order for development.

The tool can be further configured to save user preferences for a given schema. One example of this is that for a given schema, the user can specify what controls to use for each elements and properties of those elements. That information will be stored and reused whenever the UI is generated for that specific schema. Thus, when the user logins in to the system or response to a system prompt with user information, the tool can then automatically invoke those user preferences during the development process.

It is further to be appreciated by one skilled in the art that metadata associated with the platform can be stored with the data source, such that a connection to the data source automatically brings forth a richer UI than what might be stored on the platform. Of course, this can work in reverse, where the user device (or platform) is configured to utilize a less robust UI when connecting to the data source, depending on the capabilities of the data source and/or the device.

The tool can be suitably configured invoke consistency and/or policy-based control over the development process by allowing only certain types of control objects, and by further overwriting some controls, but not others. This can be performed at the end of the development process, or it can be implemented as a real-time trigger at the time the user enters the control such that if the user introduces an unauthorized control, the tool automatically alerts the developer of the improper control.

The tool can automatically determine if data strings of the data source are a certain size, and thus, automatically creates the control appropriately to accommodate the data string. In one implementation, metadata related to minimum and maximum string lengths can be employed to determine control sizes.

In another aspect of the present invention, the creation of a UI based on a first schema can be adapted for use with another data source that has the same schema.

In a more complex implementation of the present invention where a multi-dimensional database is employed, the system can provide many predefined permutations. For example, for perspective, the UI can be configured to show depth parameters related to the multi-dimensional aspects of the data source. This also provides extensibility in accommodating future data source structures and types.

The manufacturer can provide a number of default and special controls and development features in the initial production, and then update the tool software over time with enhancements. However, given that this is a development tool, and that a customer may generate their own customized templates, the capability is provided such that the customer can consume a template or parts thereof using a scanning and/or recognition software to lift all or parts of the template for customized use.

The inference component 602 provides artificial intelligence capabilities. The subject invention (e.g., in connection with selection) can employ various artificial intelligence based schemes for carrying out various aspects of the subject invention. For example, a process for determining when a form or set of forms should be used can be facilitated via an automatic classification system and process. Moreover, where the use of controls can be based upon the type of data source, the classifier may be employed to determine which controls can or must be used in accordance with policy-based criteria or other criteria, for example.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of UI development frameworks, for example, attributes are words or phrases or other data-specific attributes derived from the words (e.g., database tables, the presence of key terms), and the classes are categories or areas of interest (e.g., levels of priorities).

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module.

Thus, the classifier(s) may be used to automatically determine according to a predetermined degree of certainty when to bind certain controls to data, and when alert the user to other controls that will not bind. The user can then manually address the rejects control types for the given data source. This can apply, for example, where a given form is used on one platform, and then used gain to a web service call that also returns the same type of data.

In another example, the classifier can be used to track user preferences during past development phases, and then automatically employ those preferences in a future development process. This can be based on the user, the type of data source data, importance of the data, and the platform being used, for example.

In another implementation of the classifier, once the data source is selected, the classifier can scan the data source entities, generate the schema information, and pull together a suggested set of controls and forms for use by the developer. This can be based on the type of platform, the type of data source, viewing preferences of the data source, and other criteria. This also can include analyzing past any previously developed UI for compatibility with the existing data source. The developer can insist on a 100% compatibility, or even a less than perfect match, yet a high degree of compatibility that results in minimal interaction by the developer to manually resolve any incompatibilities.

Through schema inference, the invention can also produce UI that enforces constraints on the kind of interactions the end user can have with the data, which is important for maintaining the integrity of the data source. For example, the inference engine could generate UI that prohibits users from modifying fields in the data source that are marked as read-only, it could prevent end users from entering invalid or improperly formatted data types (e.g., a phone number where a social security number is expected), or it could even intelligently determine whether a field should be hidden from the UI (e.g., auto-incremented key columns and private fields).

Referring now to FIG. 7, there is illustrated a system 700 of the present invention where the structure of the UI defines the structure of the data source. The system 700 includes the UI generation component 102 that facilitates creation of the UI, a schema generation component 702 in communication with the UI generation component 102 that facilitates creation of the data source schema, and a persistence component 704 that facilitates persistence of the data schema into a data structure for receiving data. The system 700 also includes the inference component 602.

In this implementation, the user developments the UI first, using the UI generation component 102. The schema creation component 702 then receives the table headings and associated data table structures, and generates schema metadata. The metadata is then used by the persistence component 704 to create the corresponding data tables in a new data source for receiving data. This can occur in a piece-meal fashion, as before, or all at once after the UI has been created in its entirety. In the former case, once the user enters a control or a number of related controls into the UI form, the corresponding field information can be used to develop the schema data, which schema data is then forwarded to the persistence component 704 to create the corresponding data structure at the data source. In the later case, once the UI has been created in its entirety, the schema data is created, and passed to the persistence component for generating the tales structures at the data source.

In another implementation, the order in which controls are implemented can dictate the way the data source is structured. Since a data source may contain tables that are in a parent/child relationship, use of a first control can be considered the parent, with subsequent related controls automatically determined to children of that parent. Thus further defines corresponding table relationships at the data source.

The inference component 602 interfaces to all three components (102, 702, and 704), and can be used for explicit and/or implicit training to further automate development processes. For example, based upon preferred UI controls and forms employed previously by a particular user, the inference component 602 can automatically cause the schema to be generated and the data source to be structure accordingly. Moreover, the automation can be employed based upon a particular type of data. For example, if the data is related to banking, the inference component 602 can be employed to automatically utilize previous forms employed for a similar banking UI, and then cause the schema to be generated and the data source to be created by the persistence component 704.

Additionally, the type of platform can be a consideration such that when prompted, the user enters the type of platform, and one or more other criteria that causes the inference component 602 to automatically pull together according to some high degree of certainty the forms, controls, and views needed to complete a fully functional UI, data source schema, and data source.

Many other implementations in accordance with the present invention are within contemplation. For example, based on the operability, efficiency, etc., of the data source created and the platform employed, the inference component 602 can further enhance the structure of the data source by suggesting changes in the UI to effect these improvements as the data source and platform interact over time.

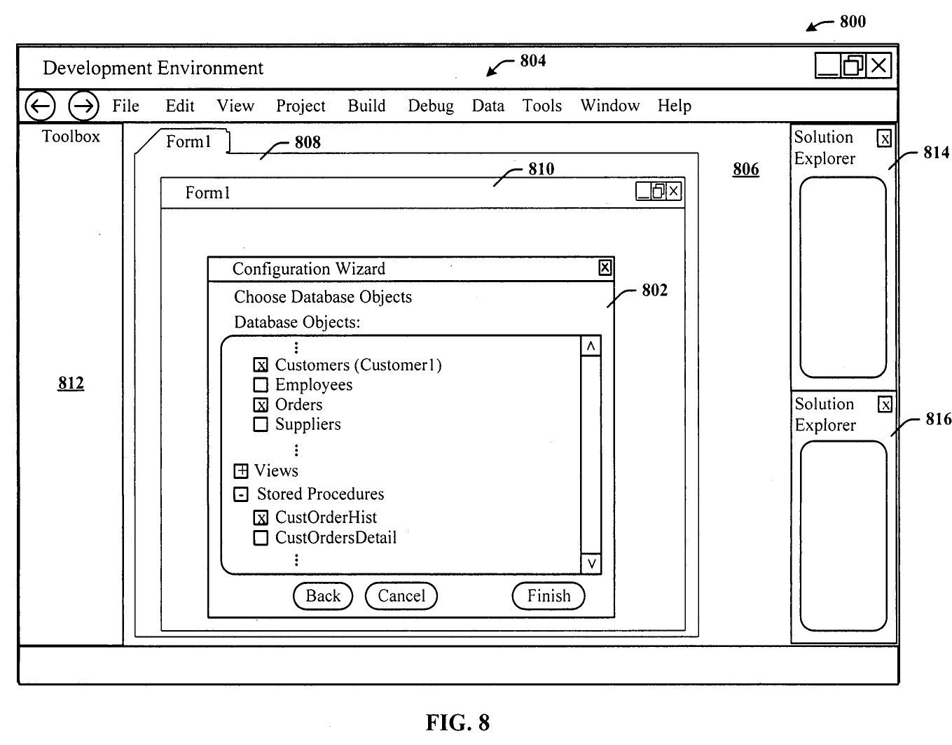

Referring now to FIG. 8, there is illustrated a sample tool development environment screenshot 800 for selecting sample UI controls via a configuration wizard 802. In this embodiment, the environment 800 includes a main menu 804 of menu options selectable by the developer for creating the UI. Here, the menu options include, but are not limited to File, Edit, View, Project, Build, Debug, Data, Tools, Window, and Help. The environment 800 includes a central work area 806 in which a form workspace 808 is presented. The user can employ one or more forms 810 in the form workspace 808 in order to create the UI.

The configuration wizard 802 is presented in the foreground, and lists a number of database objects extracted from the data source of the associated project. In this example, the data source is related to business accounting transactions. For this example, the user has selected Customers (for a Customer1), Orders related to Customer1, and the order history of the Customer1.

The environment 800 includes a toolbox area 812 where a number of tools can be employed to facilitate creation of the UI. These tools comprise windows application components, device controls, data, other components, and windows forms, for example. On the right side of the environment 800, there are provided explorer windows (814 and 816) that facilitate the presentation of the user-selected objects from the wizard 802 while the user works in the central area 806.

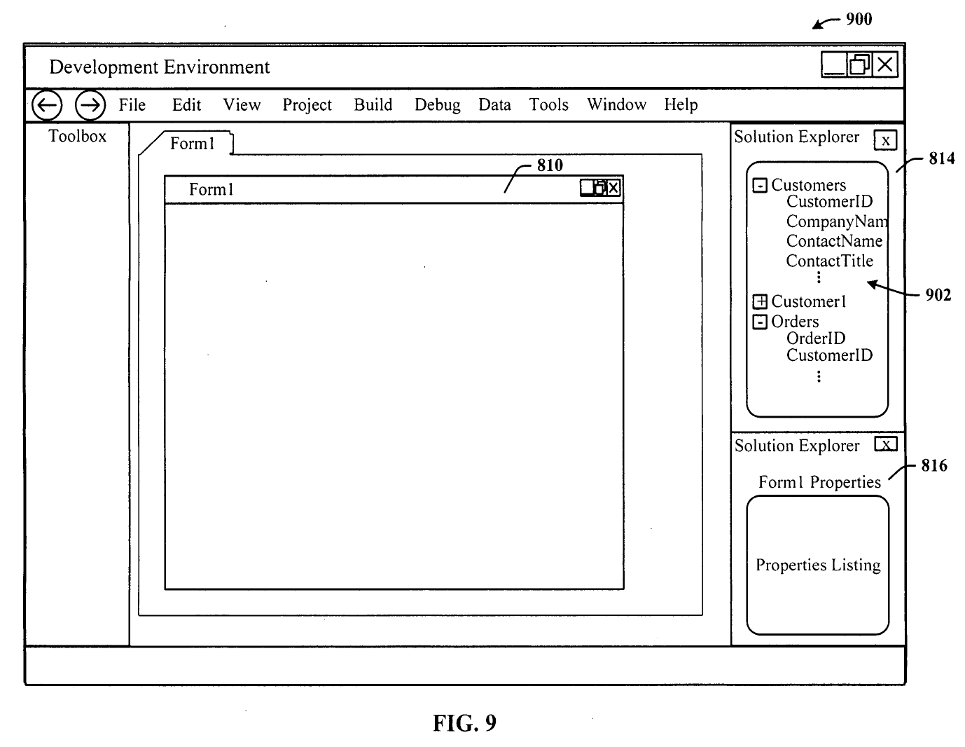

Referring now to FIG. 9, there is illustrated a tool development environment screenshot 900 after the database objects have been moved to the explorer windows (814 and 816). The upper explorer window 814 facilitates an expanded view 902 of the Customers object and Orders object. The Customers object includes table columns or data source schema elements (or entities) of CustomerID, CompanyName, ContactName, ContactTitle, and others not shown (Address, City, Region, PostalCode, Country, Phone, and Fax, to name a few). The Orders object includes data source schema elements of OrderID, CustomerID, and others not shown (EmployeeID, OrderDate, RequiredDate, ShipName, and ShipAddress, to name a few). The lower explorer window 816 can be used to further display properties associated with the form (denoted form1) 810 used. A properties listing 904 can include, but are not limited to information related to margins, minimum and maximum box size, menu, minimum and maximum form size, opacity, padding, size grip style, start position, and tag information.

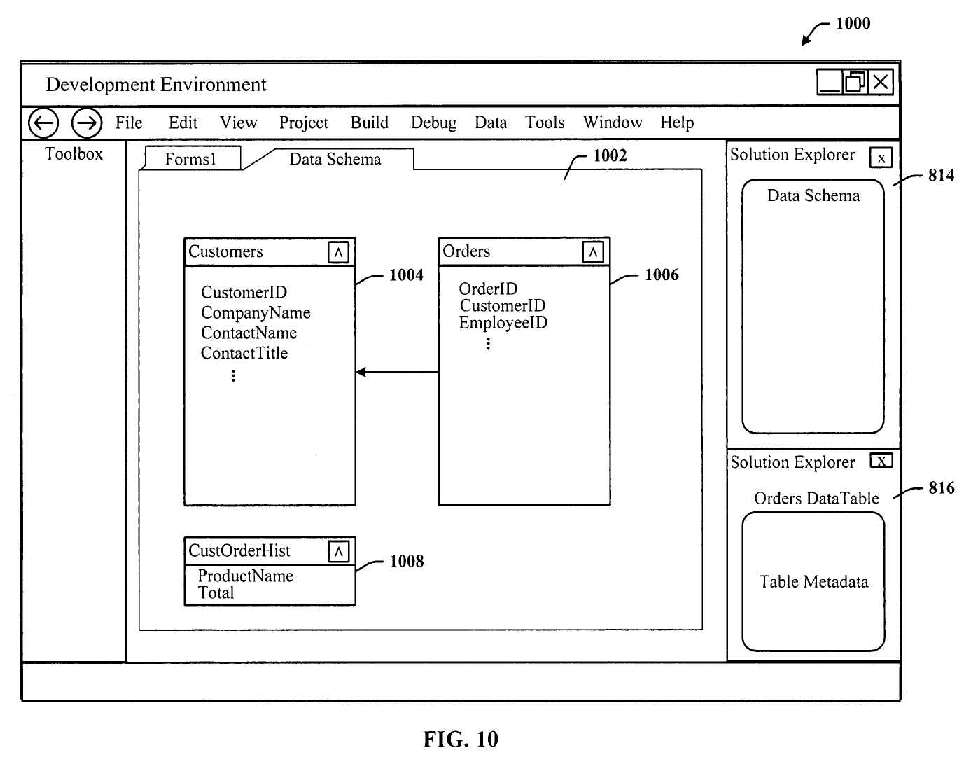

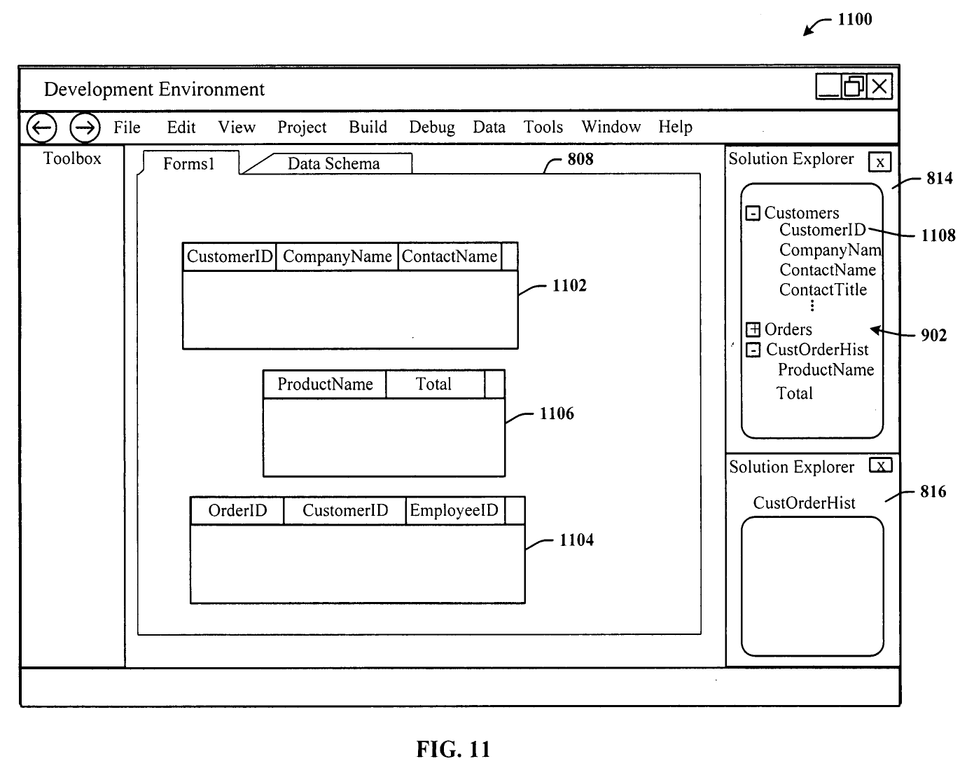

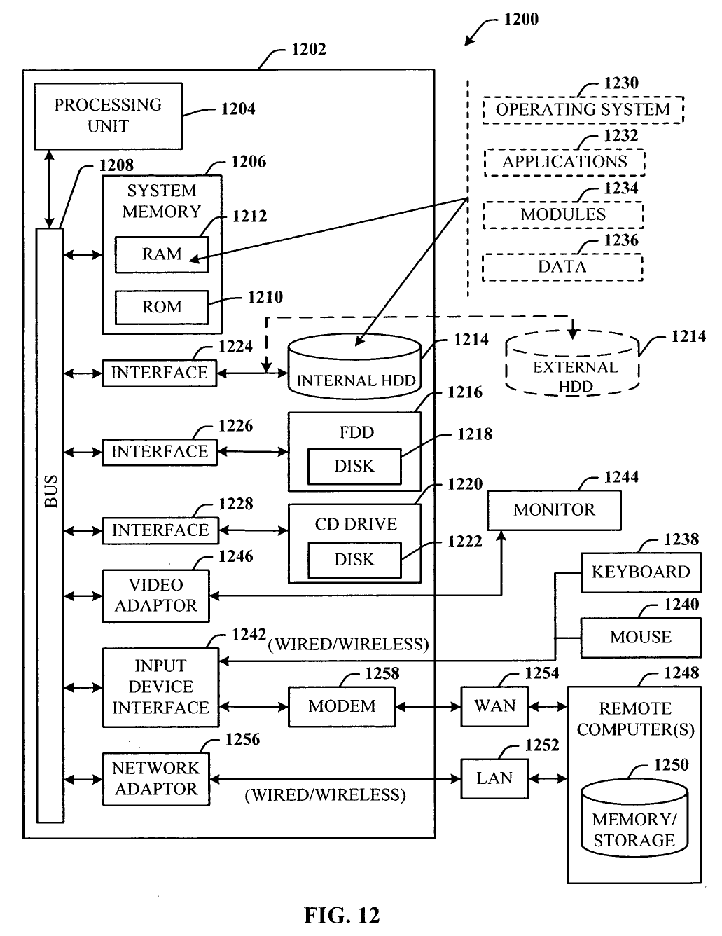

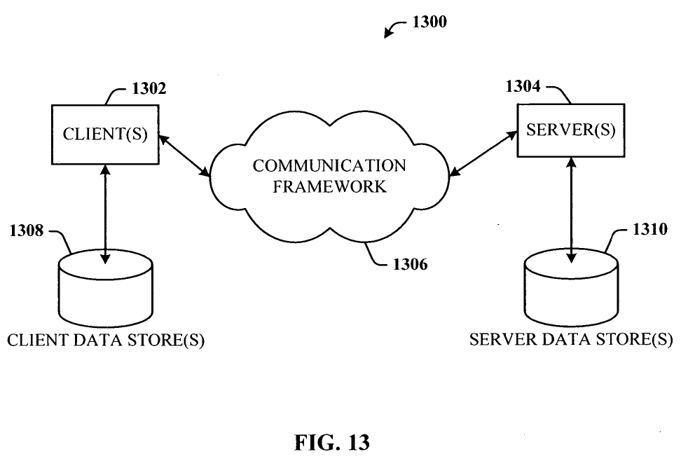

Referring now to FIG. 10, there is illustrated a tool development environment screenshot 1000 of a data schema form 1002 used for associating data source objects. Here, the user brings the Customers object 1004, Orders object 1006, and stored procedures (CustOrderHist) object 1008 into the UI, and defines the relationship of the Orders object 1006 to the Customer object 1004. The lower explorer window 816 can be employed to display Orders data table settings, that include, for example, information related to text case sensitivity, command text, command type, connection, and expression displaying.

Referring now to FIG. 11, there is illustrated a tool development environment screenshot 1100 of the controls that are generated for use with the data source objects. As indicated herein, the developer is provided flexibility in developing the UI, at least insofar as which of the controls or the data objects is created first. Here, the user has generated the Customers controls 1102 related to the Customers data objects, the Orders controls 1104 related to the Orders data objects, and the Customer Order History controls 1106 related to the CustOrderHist stored procedure.

Presented in the upper explorer window 814 are the data objects. The Customers data objects are shown in an expanded view, as are the stored procedures objects. The Orders data objects are present in a compressed mode but can be expanded to complete the data binding process. In order to complete the data binding process, the user simply drags and drops the data object from the upper explorer window 814 on top of the corresponding control. Thus, the user drags the CustomerID object 1108 on top of the CustomerID control in the Customers control 1102 panel 1102. Binding for the other data objects and control is performed in a similar manner.

Following is a more detailed description of various aspects of the present invention. The holy grail of data access is to build a set of tools that are so easy that developers new to a development framework can just walk up and use the tools. A first step towards this goal is making sure the entry points into the data tools can be quickly discovered. Given the possible large surface area of a development environment and the diversity of customers, there must be data access entry points scattered in key locations throughout the product.

Data Menu

The “Data” menu contain key launch points for all data activities. The menu can be made always visible and contains a “Connect to Database . . . ” command that adds a data connection to data source explorer application. Additional items can be hidden or displayed depending on context (e.g., whether a project or a specific designer is open).

| Command | Scope | Description |
|---|---|---|
| Connect to | Global | Adds data connection to Server Explorer. |
| Database . . . | | |
| Create Data | Language | Launches the data form builder dialog and |
| Form . . . | Project | generates a new data form (an optional |
| | | implementation) |
| Create | Language | Launches the DataSource dialog and adds |
| DataSource . . . | Project | a new DataSource (or adds to existing) |
| Show Data | Forms | Pops up Data Sources window to view |
| Source | designer | and consume logical data sources, the |
| Window | | schema elements contained, and the fields |
| | | for each of those elements. |

Data Form Project Item

The project items contain a Data Form template that launches a DataForm builder dialog and generates a Form with the selected databound UI and a DataSource.

Data Source Explorer

The Data Source Explorer allows a user to connect to a physical database, manage the contents thereof, and drag/drop items onto different designers. The Explorer provides a shortcut for application development against a database.

Logical Data Explorer

A DataSource Fields picker allows the user to browse and generate UI from any project DataSource that can provide a schema. This provides much higher fidelity with appearance and behavior of the data used in the application, which may be consumed from a database, web service, business object, or other middle tier component. This tool window is also referred to as the “Logical Data Explorer” because it provides a logic view of the data as it is used in the application. The DataSource Fields picker also enables the user to customize the default UI controls that will be generated during the drop, including UI defined in custom control libraries. Users can drag/drop these objects onto different designers as described hereinbelow.

Drag/Drop from Data Explorer(s)

The development environment tools allow powerful drag/drop capabilities that for visually designing working dataforms without having to write any code. Specifically, dragging and dropping of data objects from the data source explorer to a form or component generates the following: configured data access logic (SQL commands, connections); DataSources, including relationships between tables; Databound UI; and configured DataAdapters.

Drag/drop output is generated for each software designer using defaults. The defaults are pre-configurable in a drag sources and data options. The user may also modify the dropped result using designer tasks. Defaults may be overridden on every drop using right-clock-drag, for example. When a data object is dropped onto the designer template using right-drag, a menu is presented presenting the user with options. The menu is tailored for the particular designer. For example, options for generating databound UI are not shown for a component designer.

Data Explorer Drop Menu

When users drag/drop a Data Source Explorer item onto the designer with right-drag, a menu is displayed offering them a choice of actions to take. Depending on the drag source and the drop target, the menu choices are different. In all cases, a DataSource containing the selected table/method is automatically generated as well. Additionally, non-visual data objects are generated from database connections in the Data Source Explorer, and can be called out specifically. Following is one example of the menu. However, in another implementation, the menuing system is more flexible and customizable. For example, a user can define their own type <-> control mappings and the UI can be generated not only for databases, but also other data sources.

Menu Options

| Menu | Sub Menu | Result (Windows Project) | Drag Sources | Drop Targets |
|---|---|---|---|---|
| Create | Master- Detail | Sequence of textboxes | Multi-selected | Windows |
| | Form | bound to a DataSource, | Tables or | Form |
| | | navigation control; | columns within | |
| | | Databound bound to | Tables | |
| | | related child table | | |
| | Details Form | Sequence of controls | Table/Columns | Windows |
| | | bound to a DataSource; | View | Form |
| | | navigation control | Stored | |
| | | | Procedure | |
| | | | (resultset) | |
| | | | Table | |
| | | | Functions | |
| | | | Multiple | |
| | | | Columns | |
| | Grid | TableControl bound to a | Table/Columns | Windows |
| | | DataSource (we will use | View | Form |
| | | the DataGrid until the | Stored | |
| | | table comes online) | Procedure | |
| | | | (resultset) | |
| | | | Table | |
| | | | Functions | |
| | Data Input | A control for each | Stored | Windows |
| | Form | parameter of a stored | Procedure with | Form |
| | | procedure, a DataSource | parameters | |
| | | Function for the stored | | |
| | | procedure, and a button | | |
| | | to call the function with | | |
| | | control values as | | |
| | | parameters. | | |
| | Lookup | Combo box with | Table/Columns | Windows |
| | Combobox | DataSource, | Table Function | Form |
| | | DataMember, and | | |
| | | DisplayMember bound | | |
| | | to the table, primary | | |
| | | key, and description | | |
| | | field respectively | | |
| | DataSource | DataSource only, no UI. | Table/Columns | Windows |
| | | | View | Form |
| | | | Stored | Component |
| | | | Procedure | |
| | | | (resultset) | |
| | | | Table Function | |
| | | | Connection | |
| | DataSource | Typed DataReader only, | Table/ | Component |
| | Reader | no UI | Columns | |
| | | | View | |
| | | | Stored | |
| | | | Procedure | |
| | | | (resultset) | |
| | | | Table Function | |
| | DataSource | DataSource containing | Scalar Stored | Windows |
| | Function | top level wrapper | Procedure | Form |
| | | function | Scalar | Component |
| | | | Function | |
| | DataAdapter | Fully configured Data | Table/ | Windows |
| | | Adapter and DataSource | Columns | Form |
| | | | View | Component |
| | | | Stored | |
| | | | Procedure | |
| | | | (resultset) | |
| | | | Table Function | |
| | Data | Configured | Stored | Windows |
| | Command | DataCommand | Procedure | Form |
| | | | (scalar) | Component |
| | | | Scalar | |
| | | | Function | |
| | Data | DataSource with | Connection | Windows |
| | Connection | configured data | | Form |
| | | connection | | Component |
| Cancel | (none) | Drag/drop is optional | All | All |

Additional Menu Options for Single Column Drag

The following menu options can be displayed in place of the Databound Form option, if the user drag/drops a single column from Data Source Explorer of the associated type.

| | | Result (Windows | | |
|---|---|---|---|---|
| Menu | Sub Menu | Project) | Drag Sources | Drop Targets |
| Create | TextBox | Textbox.Text | String, | Windows |
| | | | DateTime, | Form |
| | | | Boolean, | |
| | | | Int32, | |
| | | | Decimal, | |
| | | | Single, | |
| | | | Double, Guid | |
| | Label | Label.Text | String, | Windows |
| | | | DateTime, | Form |
| | | | Boolean, | |
| | | | Int32, | |
| | | | Decimal, | |
| | | | Single, | |
| | | | Double, Guid | |
| | CheckBox | Checkbox.Checked | Boolean | Windows |
| | | | | Form |
| | DateTimePicker | DateTimePicker.Value | DateTime | Windows |
| | | | | Form |
| | MaskedEdit | MaskedEdit.Text | String, | Windows |
| | | | DateTime, | Form |
| | | | Boolean, | |
| | | | Int32, | |
| | | | Decimal, | |
| | | | Single, | |
| | | | Double, Guid | |
| | LinkLabel | Linklabel.Text | String, | Windows |
| | | | DateTime, | Form |
| | | | Boolean, | |
| | | | Int32, | |
| | | | Decimal, | |
| | | | Single, | |
| | | | Double, Guid | |
| | NumericUpDown | NumericUpDown.Value | Int32 | Windows |
| | | | | Form |
| | ComboBox | ComboBox.ValueMember | String, | Windows |
| | | | DateTime, | Form |
| | | | Boolean, | |
| | | | Int32, | |
| | | | Decimal, | |
| | | | Single, | |
| | | | Double, Guid | |
| | ListBox | ListBox.ValueMember | String, | Windows |
| | | | DateTime, | Form |
| | | | Boolean, | |
| | | | Int32, | |
| | | | Decimal, | |
| | | | Single, | |
| | | | Double, Guid | |
| Cancel | | | | |

Stored Procedure Drops

Provided is the capability to drag/drop parameterized stored procedures onto a form and have a UI both for entering parameter values and displaying the results. Similar functionality includes cases such as dragging a DataSource table with a parameterized query from a logical view. The model can work as follows: (1) for any parameterized sproc/query, we create input controls for each parameter. The type of the control depends on the data type of the parameter, and the same mapping is used that is specified for returned fields (e.g., checkbox for Boolean, textbox for string, and datetimepicker for date); and (2) whenever the user drag/drops something and asks us to generate UI, a “Load” button and an OnClick handler are generated. The handler retrieves any values from the parameter controls, passes them into the sproc or query, and executes them.

The generation menu options are affected as follows: (1) the functionality of a Master-Detail Form, Databound Form, and Data Grid options are extended to handle input parameters, if the parameters exist, and to generate a Load button. These commands would continue to generate the UI for displaying results as currently specified; and (2) if the user drag/drops a scalar sproc or function, the menu will include a new option call “Input Form” that would have input controls and a Load button (probably called “Execute”).

An additional benefit of this approach is that the Load button provides a more robust way to create no-code data forms that work with parameterized queries/sprocs, and do not rely on AutoFill in runtime objects.

Multi-Object Drops

Users may multi-select and drop many different combinations of objects onto a form (e.g., a Table and View, and a stored procedure and a column). Objects in the Data Source Explorer can be classified as Tabular (e.g., Tables, Columns, Table Stored Procedures, Table Functions) and Scalar (e.g., Scalar Stored Procedures, Scalar Functions). The rules determining what should be displayed in the menu depend upon whether the drag contains members of either or both of these categories.

Dragging Multiple Tabular Items

If the drop contains two or three tables with a parent-child-grandchild relationship, the master-details option is displayed, in addition to the single table options. If master-details is selected, the form UI is generated for the parent table, and the grid UI is generated for both the child and the grandchild. Otherwise, grids or forms are generated for each table.

If the drop contains three tables that do not have a parent-child-grandchild relationship, the designer displays the menu options available for a single table. If the user selects any of the UI options, the UI is generated for all three tables. For example, if the user selects DataGrid, three grids are generated and bound to the three tables.

If the drop contains more than three tables, the designer does not display any UI options on the menu; only data options are displayed.

Dragging Multiple Scalar Items

If the selection contains multiple scalar items, the menu contains all options relevant to scalar values (DataSource Functions, Data Commands).

Dragging Tabular and Scalar Items

If the drop contains both tabular and scalar items, the options on the menu are governed by the tabular items according to the associated rules. Additionally, options that do not entail generating DataSource are not displayed (e.g., DataAdapter, DataCommand). Both scalar and tabular items are added as functions and tables to the DataSource. The scalar items do not affect the generated UI.

Designer Task (Smart Tag Support)

Immediately after a drag/drop, the designer will show a designer task in the form of a “smart” tag that allows the user to select an alternative drag/drop option.

Generating the DataSource

When the user drag/drops from the Data Source Explorer, the data designtime gathers metadata from several places in order to determine what menu options to present, and what code to generate.

Generating the DataSource

When the users selects a menu option that entails creating a DataSource, the designer merges the in-memory DataSource into the user project. If the project does not contain a DataSource, a new one is created and the selected objects are added. If a single DataSource exists, the object is added to that DataSource. If more than one DataSource exists, a resolver dialog is displayed asking which DataSource to use.

Merging DataSource Schema

Once the designer has determined which DataSource to use, it determines how to incorporate the new object into the DataSource. New schema from drag/drop is additively merged into existing schema, that is, in on embodiment, drag/drop can add or modify DataSource schema and not be removed from it. In another embodiment, however, it is removable.

The designer software merges table schema as follows. First, the designer compares the name of the drag/drop source table with the source names of tables already in the DataSource. The name comparison is against the original, pre-mapped table names. To speed up performance, the designer can cache source table names whenever queries are configured rather than attempting to reparse the query every time. If no match is found, the new table is added. If a match is found, any field(s) not already in the table are added. The metadata of any existing fields are refreshed with those in the database (e.g., data type, constraints, auto-increment, etc.). However, user-defined captions on the fields are preserved.

In some cases, the DataSource may contain more than one data component querying a given source table in the database, where the data component can interact with an external data source. If the designer finds two table matches in the DataSource, a resolver dialog is displayed to the user to determine which table the new data should be merged. The data component will have a master query and possibly one or more data functions associated with it. These queries may in turn call stored procedures (sprocs) or dynamic SQL. Schema merges are automatically applied to all dynamic SQL queries associated with the table.

Generating Databound UI

With respect to mapping DataSource types to controls, the designer software generates UI appropriate for displaying the underlying data type. Given that the Windows Forms controls are bound to the DataSource rather than the underlying database, the designer need only define a mapping between the schema types in the DataSource and controls for displaying those types. The designer is not directly concerned with the underlying database types.

Type Mappings

The table below lists the mappings between each drag source and the corresponding generated UI. In cases where multiple UI options are possible, the default is listed in italics. The default is used by all features that have not been re-configured by the user. The mappings also indicate which datasource items can be dragged onto which existing controls, and which controls are suitable conversions.

| DataSource | |
|---|---|
| Object | Windows Form Control |
| Table or | Grid, Table, Details Form, ComboBox |
| Multi-column | |
| selection | |
| DateTime column | DateTimePicker, Textbox, Label, MaskedEdit, |
| | LinkLabel, ComboBox, ListBox |
| Boolean column | Checkbox, Radio Button, Dropdown List, Textbox, |
| | Label, MaskedEdit, LinkLabel, ComboBox, ListBox |
| Int64, Int32, | Textbox, Label, MaskedEdit, LinkLabel, ComboBox, |
| Int16 column | ListBox, NumericUpDown (spinner) |
| Decimal column | Textbox, Label, MaskedEdit, LinkLabel, ComboBox, |
| | ListBox |
| Single, Double | Textbox, Label, MaskedEdit, LinkLabel, ComboBox, |
| column | ListBox |
| Byte[ ] column | Label (“Object” with Tag), PictureBox, Textbox, |
| | MaskedEdit, LinkLabel, ComboBox, ListBox |
| Object column | Label (“Object” with Tag), PictureBox, Textbox, |
| | MaskedEdit, LinkLabel, ComboBox, ListBox |
| Guid column | Textbox, Label, MaskedEdit, LinkLabel, ComboBox, |
| | ListBox |

When a third party control feature is added to the drag-drop end-to-end scenario, the list above also enumerates the list of supported third party controls and a “Custom control . . . ” command link.

DataContainer, DataForm, and DataConnector Integration

The DataContainer is a visual control and essentially a Windows Forms panel control that is data aware, that is, it has a datasource, and other controls bind to that datasource indirectly. This greatly simplifies the design-time experience and code required to manage data binding, currency, and DataViews for all controls bound to the same underlying data.

The DataForm is a sub-class of the Windows Form class, which behaves like a Form with a dock-filled DataContainer class. Users may set the DataSource and DataMember properties on the form, and then bind to the form. All controls and sub-containers added to the form have a data-binding context already. Users are guided down paths that take advantage of these controls on all default drag/drop actions, as using the DataContainer is important in enhancing the user experience.

A DataConnector component serves a similar purpose as the DataContainer, but it is non-visual control. The user provides feedback that having container control is too restrictive for their UI layout.

Scenarios

Scenarios that can be enabled include the following. The DataContainer and all of its controls are bound to a single table. Note that a container is a form in the work area of the development tool. This simple case is used by many applications. To enable this, the DataContainer or DataForm have a DataSource/DataMember bound to the single table, and controls inside the container are all bound to the container. In anther scenario, the DataContainer is used for Parent-Child related data. To enable this, at least two DataContainers are used. The outer container and its contained controls correspond to the parent table data. The nested container is bound to the parent-child relationship, which can be thought of as the view on child details that pertain to the parent. Customers and Orders, and Orders and OrdersDetails are examples of parent-child related tables.

In yet another scenario, DataContainer and its controls are bound to a single table.

However, the developer may wish to layout some of the controls outside of the DataContainer rectangle, while still binding to the DC. In another scenario, multiple DataContainers exist on the form, but are bound to non-related tables. It is common to use multiple datasources on a form that are not related.

Manual scenarios include where multiple DataContainers that exist on the form are bound to the same underlying table. This feature allows a user to yield a new DataView or CurrencyManager for groups of controls. Another manual scenario involves details controls that exist on the form and are directly bound to the same table as a peer DataContainer. What this means to the user is that these controls do not obey the same load, filtering, sorting, and currency view behaviors that other controls will when bound to the DataContainer.

Drag/Drop Rules

The general algorithm for drag and drop in the context of DataContainer is to:
drop a DataContainer on the form (the DataSource/DataMember property is set appropriately).
   If the DataContainer already exists on the drop area, and its:
      DataSource Is Nothing, set DataSource/DataMember.
      DataSource IsNot Nothing, use the same DataContainer.
      Else add a new DataContainer with DataSource/DataMember set.
   Else add a new DataContainer with DataSource/DataMember set.

The following table details the behavior for a particular drag object and drop target.

| | Drag object | | | | |
|---|---|---|---|---|---|
| Drop | | | GrandChild | | |
| Destination | Matching table | Child table | table | Parent | Non-related |
| DataForm | Bind | Create | Create | Create new | Create new |
| Dock-filled | controls to | nested DC | double | DC | DC |
| DataControl | destination | Drop | nested DCs | Drop | Drop |
| Inside | DC | controls | Drop | controls | controls |
| DataControl | Drop | inside | controls | inside | inside |
| (configured) | controls | Bind to | inside | | |
| | inside | nested DC | innermost | | |
| | | | DC | | |
| | | | Bind to | | |
| | | | innermost | | |
| | | | DC | | |
| DataForm | Bind | N/A | N/A | N/A | N/A |
| Dock-filled | controls to | | | | |
| DataControl | destination | | | | |
| Inside | DC | | | | |
| DataControl | Drop | | | | |
| (not | controls | | | | |
| configured) | inside | | | | |
| | Set DS/DM | | | | |
| Outside | Bind | Bind | Bind | Bind | Bind |
| existing | controls to | controls to | controls to | controls to | controls to |
| DataControl | matching | matching | matching | matching | matching |
| | DC | DC | DC | DC | DC |
| | Drop | Drop | Drop | Drop | Drop |
| | controls | controls | controls | controls | controls |
| | outside | outside | outside | outside | outside |
| DataControl | Create new | Create new | Create new | Create new | Create new |
| does not | DataControl | DataControl | DataControl | DataControl | DataControl |
| exist | Drop | Drop | Drop | Drop | Drop |
| | controls | controls | controls | controls | controls |
| | inside | inside | inside | inside | inside |
| Outside | Prompt for | Prompt for | Prompt for | Prompt for | Prompt for |
| DataControl | which DC to | which DC to | which DC to | which DC to | which DC to |
| and multiple | bind to | bind to | bind to | bind to | bind to |
| exist | (OK/Cancel) | (OK/Cancel) | (OK/Cancel) | (OK/Cancel) | (OK/Cancel) |
| | Drop | Drop | Drop | Drop | Drop |
| | controls | controls | controls | controls | controls |
| | outside | outside | outside | outside | outside |

AutoLoad Rules

AutoLoad is set to true by default on new DataContainers.

Exceptions where AutoLoad=False, include the following: the default query for a DBTable requires parameters or cannot be auto loaded; parameterized Query smart task needs to spit parameterized query code and disable AutoLoad; and AutoLoad is already set to False.

Smart Tasks Enabled

The following smart tasks are enabled off the DataContainer: Add Parameterized Form . . . ; Add Child Form . . . ; and Change To {Grid, Details Form, [tabular drop objects . . . ]}.

Variable Naming The designer uses guidelines for naming the variables of generated controls. The variable naming pattern is <hungarian prefix>+<object name>, where <prefix> is the standard hungarian prefix for the control type (see the table below), and <object name> is the name of the corresponding table, column, or parameter in the corresponding DataSource object. For example, a Textbox bound to the CustomerID field would be named “txtCustomerId”. A ComboBox whose SelectedValue is bound to the Region column would be named “cboRegion”. If a variable of a given name already exists, a uniquefier (unique identifier) is appended to the name.

Variable Naming Prefix Table

| Prefix | Windows Forms Tab |
|---|---|
| btn | Button |
| chk | CheckBox |
| cbo | ComboBox |
| frm | Form |
| lbl | Label |
| lst | ListBox |
| mnu | MenuItem |
| pic | PictureBox |
| rtf | RichTextBox |
| sbr | StatusBar |
| tab | TabControl |
| txt | TextBox |
| grd | DataGrid |
| tmr | Timer |
| dlg | ColorDialog, FontDialog, OpenFileDialog, |
| | PageSetupDialog, SaveFileDialog, PrintDialog |
| | PrintPreviewDialog |
| ctrl | Everything else |

Dragging Onto Existing Controls

The user may databind controls by dragging and dropping data fields onto those controls. This scenario is also referred to as “Connect the dots data binding”. For simple and complex databound controls, the target control is bound to the dragged datasource. If it was previously bound, it is rebound to the dragged fields. For example, if a datagrid was bound to customers and the user drags orders, it is rebound to orders. If the grid was bound to all columns in the customers table, and the user drags just the id and name column, the grid is rebound to just the id and name columns.

Dragging a field onto a control may or may not be allowed depending upon the type of both. The Type Mappings table above lists all of the allowable combinations of fields and controls.

The data designers can discover whether or not a control supports simple or complex data binding and its relevant properties through a set of attributes. Users can drag/drop onto other application controls that support these attributes.

Binding to Form or Global Instances

Although the databinding model is focused on the concept of global DataSources, it is possible for all language users to add DataSources instances to the Form, as well. Whenever the data source Explorer items are dragged onto a form, the drop handler checks if an instance of the DataSource exists on the Form. If so, any generated controls are bound to the form instance rather than to the global instance.

Logical Data View—Bind Data to Form

The user intends to connect to some datasource, and bind to the data in a form. The general sequence of tasks is the following: connect to a new or existing DataSource; bind the Form, Container, or controls to the DataSource; and add specific controls to the form that map to DataSource fields. The DataSource fields picker gives the user insight to the data available in the project at each stage, and makes it easy to perform each task.

Logical Data View—Create a New Project

The user creates a new project, and sees a blank form and no data in the project. The DataSource fields picker hovers right next to the form, displays a message that no project datasources are available, and provides a quick shortcut to Add New Datasource . . . The user adds a Datasource and may then proceed to the next task.

Logical Data View—Create a New Form in Project with Existing Data The user has already added DataSources to the project, and now needs to use this data in their form. If the user has the “Project DataSources” filter on, they will see the data and, can drag and drop one or more fields. If the user has the “Form DataSources” filter on in a form with no existing DataSources, they see a shortcut to view project datasources. If the user has the “Form DataSources” filter on in a form that is bound to existing DataSources, the user sees just those DataSources. This makes it easy to iterate on the design of a form that is already bound properly.

Logical Data View—Changing Default UI Drop Results

The user has become quite comfortable dragging and dropping fields to generate UI with the defaults, and can use progressive discovery features like the designer tasks to convert UI, but would now prefer to systematically change the defaults for field in the schema before doing the drop. She uses the dropdowns next to each item in the picker to pre-configure the drop result. The UI results may be configured field by field, and the results for a table or multi-selection can be pre-configured. Additionally, many users may have paid for created custom controls that can databind to tables and fields of a schema. UI generation sources such as the DataSource fields picker enables the user to use their custom controls. Specifically they may use an entry point such as Custom Control . . . to add new controls (like Fox).

Logical Data View—Modifying an Existing DataSource

The user added a new data source easily using the wizard, and begins to generate UI using drag/drop. The user finds, however, that the data source is missing some information, e.g., an interesting new field or a new fill query. The user clicks on Edit DataSource, which pops up the selected datasource in the datasource designer. The user can now iterate on the design. Note that the user can use the Add New DataSource . . . wizard initially to create the datasource, but is provided a different experience for adding/removing objects from the existing datasource. A reentrant version of the wizard enables simple edits to the database reference.

Drag and drop features provide the user with the capability to select and override the default control result via a dropdown/context menu. A control default icon is indicated to the left of the tree node. A change in defaults is reflected visually by a change in icons.

The picker has several shortcut commands that make it easier for the user to work with project datasources in the context of data forms design.

A Datasource filter is a mutually exclusive set of buttons that allow the user to change the filter. Two filters that are available, include Form DataSources, which filters the list of datasources to those used on the current form only, and Project DataSources, that shows all datasources in the project. A Current DataSources filter can be implemented that shows only the datasources used by the selected form, container, or control's datasource.

Add New DataSource . . . is a shortcut to call the Add New DataSource command. Edit DataSource is a command that opens the selected datasource up in the datasource designer. Add New DataSource can be a re-entrant wizard and has an associated command to initiate it.

Differentiating Drop Objects Based on Project Datasource Type

This feature reflects the schema of a particular datasource, and enables drag/drop based on the shape of this schema. The user can drag/drop from middle tier objects (web services, objects, etc). The picker allows drag and drop from this schema, and the user can write the code that loads and saves instances of data. In one implementation, the picker enables binding to the most common methods that load and save data.

Customizing UI Generation

The disclosed development tool can supports the capability to customize the result to the customer's preference. The areas of customization include customizability of the actual drop result (e.g., setting up the mask on a masked edit control); extensibility to 3^{rd} party and custom control libraries; and customizability of the list of drop results for designers or projects that host these features (e.g., Devices and Office projects see a list of controls that are appropriate for their scenario). Custom settings are saved for the user at least one of per type and per application.

Toolbox Support

The Data Tab of the Toolbox supports the list of items below. The set that appears by default is determined by the user's profile. Additional items such as provider-specific Connections and Commands can be manually added to the Toolbox using the Customize Toolbox command. The support items include at least the following: DataSourceN, where each datasource in the users project is automatically added to the Data tab of the Toolbox just like User Controls; DataAdapter, where there is a single generic Data Adapter on the Toolbox representing all of the provider-specific DataAdapter implementations (this item launches an Adapter Configuration Wizard, and determines which provider to use based on the (managed) connection selected by the user); data component, that launches the Data Component Configuration Wizard and adds a typed DataSource containing the table to the project; DataView, which adds a DataView instance to the form; DataSet, the System.Data.DataSet; and Connection, a single generic object that when dragged launches the Connection builder dialog, allowing the user to specify a connection string and determine which provider to instance.

Data Verbs

The user may preview data live in the designer for any control that is bound to a data component on the form or a global DataSource, the mechanisms by which designtime data work differ for instances scoped globally and to the form.

Form Instances

The Data Component and DataSource designers expose “Preview Data” and “Clear Data” verbs that fill and clear the designtime object instances. Any controls bound to those instances will display those data.

Global Instances

“Preview Data” and “Clear Data” commands are exposed off each of the DataSource's tables in the logical view of the project. These commands have the effect of filling/clearing the global instances of the tables. Any UI bound to those instances will display that data.

The Preview Dialog is included in the DataSource designer.

DataAdapters continue to offer the “Generate DataSet” command, the result of which is a DataSource containing DataTables rather than connected Data Components. The user has the option to add an instance to the designer or not.

Anywhere the designer supports drag/drop, it will also support copy/paste for accessibility. Copy/Paste behaves the same as drag/drop.

Referring now to FIG. 12, there is illustrated a block diagram of a computer operable to execute the disclosed architecture. In order to provide additional context for various aspects of the present invention, FIG. 12 and the following discussion are intended to provide a brief, general description of a suitable computing environment 1200 in which the various aspects of the present invention may be implemented. While the invention has been described above in the general context of computer-executable instructions that may run on one or more computers, those skilled in the art will recognize that the invention also may be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like, each of which may be operatively coupled to one or more associated devices.

The illustrated aspects of the invention may also be practiced in distributed computing environments where certain tasks are performed by remote processing devices that are linked through a communications network. In a distributed computing environment, program modules may be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, there is illustrated an exemplary environment 1200 for implementing various aspects of the invention that includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 may be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the present invention.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212.

It is appreciated that the present invention can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but may be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers etc.

The computer 1202 may operate in a networked environment using logical connections via wired and/or wireless communications to one or more remote computers, such as a remote computer(s) 1248. The remote computer(s) 1248 may be a workstation, a server computer, a router, a personal computer, portable computer, microprocessor-based entertainment appliance, a peer device or other common network node, and typically includes many or all of the elements described relative to the computer 1202, although, for purposes of brevity, only a memory storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1202 is connected to the local network 1252 through a wired and/or wireless communication network interface or adapter 1256. The adaptor 1256 may facilitate wired or wireless communication to the LAN 1252, which may also include a wireless access point disposed thereon for communicating with the wireless adaptor 1256. When used in a WAN networking environment, the computer 1202 can include a modem 1258, or is connected to a communications server on the LAN, or has other means for establishing communications over the WAN 1254, such as by way of the Internet. The modem 1258, which may be internal or external and a wired or wireless device, is connected to the system bus 1208 via the serial port interface 1242. In a networked environment, program modules depicted relative to the computer 1202, or portions thereof, may be stored in the remote memory/storage device 1250. It will be appreciated that the network connections shown are exemplary and other means of establishing a communications link between the computers may be used.

The computer 1202 is operable to communicate with any wireless devices or entities operably disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication may be a predefined structure as with conventional network or simply an ad hoc communication between at least two devices.

Wi-Fi, or Wireless Fidelity, allows connection to the Internet from a couch at home, a bed in a hotel room or a conference room at work, without wires. Wi-Fi is a wireless technology like a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, with an 11 Mbps (802.11b) or 54 Mbps (802.11a) data rate or with products that contain both bands (dual band), so the networks can provide real-world performance similar to the basic 10BaseT wired Ethernet networks used in many offices.

Referring now to FIG. 13, there is illustrated a schematic block diagram of an exemplary computing environment 1300 in accordance with the present invention. The system 1300 includes one or more client(s) 1302. The client(s) 1302 can be hardware and/or software (e.g., threads, processes, computing devices). The client(s) 1302 can house cookie(s) and/or associated contextual information by employing the present invention, for example. The system 1300 also includes one or more server(s) 1304. The server(s) 1304 can also be hardware and/or software (e.g., threads, processes, computing devices). The servers 1304 can house threads to perform transformations by employing the present invention, for example. One possible communication between a client 1302 and a server 1304 may be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications may be facilitated via a wired (including optical fiber) and/or wireless technology. The client(s) 1302 are operably connected to one or more client data store(s) 1308 that can be employed to store information local to the client(s) 1302 (e.g., cookie(s) and/or associated contextual information). Similarly, the server(s) 1304 are operably connected to one or more server data store(s) 1310 that can be employed to store information local to the servers 1304.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that facilitates generation of a user interface, comprising:
a generation component that facilitates the use of a control in the user interface; and
a data component that accesses a data schema such that the control is associated with the data schema.

2. The system of claim 1, the generation component facilitates binding control to the data schema when a user manually associates the data schema, which includes a data field, with the control.

3. The system of claim 2, the user manually associates the control with the data schema by dragging and dropping the related data schema entity on the control.

4. The system of claim 1, the user interface is associated with a heterogeneous object that includes at least one of a database table, database stored procedure, object, and a web service result.

5. The system of claim 1 facilitates the binding of a data source to an existing user interface using the data schema.

6. The system of claim 1 facilitates the creation of multiple user interface views over the data schema.

7. The system of claim 1, at least one of a data source object, type and file can be passed to the generator component as an input.

8. The system of claim 1, the generation component generates a probable mapping of the control to an element of the data schema before applying the element to the control.

9. A computer readable medium having stored thereon computer executable instructions for carrying out the system of claim 1.

10. A computer employing the system of claim 1.

11. The system of claim 1, the data schema is associated with a multi-dimensional data source.

12. The system of claim 1, the data schema is bound to the control one of when the control is generated or after all controls have been generated.

13. The system of claim 1, further comprising an inference component that infers a state or condition and automatically performs a function in response to the inferred state or condition.

14. A system that facilitates generation of a user interface, comprising:
a generation component that facilitates the use of a plurality of controls in the user interface;
a data component that accesses a data schema such that the controls can be associated with the data schema; and
a driver component that creates a probable mapping between the controls and entities of the data schema.

15. The system of claim 14, the generation component resolves a conflict between the controls and the entities of the data schema when the probable mapping is applied.

16. The system of claim 14, the structure of the user interface determines the structure of the data schema.

17. The system of claim 14, the structure of the user interface determines the structure of a data source.

18. The system of claim 14, further comprising a persistence component that persists the structure of the user interface in order to create the data source.

19. The system of claim 14, further comprising a schema component that creates the data schema according to the user interface that was created.

20. The system of claim 14, further comprising a schema component that creates the data schema according to the user interface that was created, wherein the order in which the plurality of controls is created determines the structure of the data schema and associated data source.

21. The system of claim 14, the user interface is structured according to the platform on which the user interface is employed, the platform includes at least one of a desktop computer, a portable computer, a portable communication device, and a web server.

22. The system of claim 14, the controls are automatically selected according to a platform on which the user interface is employed.

23. A method of creating a user interface based on a data source, comprising:
generating a plurality of controls in an interface development environment;
generating a data schema that represents a structure of the data source; and
binding entities of the data schema to the plurality of controls by associating the controls and the data schema while in the development environment.

24. The method of claim 23, further comprising structuring the data source according to a sequence of steps in which the user interface is created.

25. The method of claim 23, further comprising structuring the data source according to a sequence of steps in which the controls are introduced and bound to the data schema.

26. The method of claim 23, further comprising structuring the user interface based on a platform employed to execute the user interface.

27. The method of claim 23, further comprising saving user preferences of a user such that the user preferences are automatically invoked during another development session.

28. The method of claim 23, further comprising automatically retrieving a set of forms for use in the development environment in accordance with at least one of a type of platform on which the user interface will be used, a customer for which the user interface is developed, and type of data source for which the user interface will be associated.

29. The method of claim 23, further comprising restricting use of select ones of the control according to at least one of a policy-based decision and consistency between user interfaces.

30. A computer-readable medium having computer-executable instructions for performing a method for creating a user interface in association with a data source, the method comprising:
generating a plurality of controls in an interface development environment;
receiving a data schema that is representative of a structure of the data source; and
binding entities of the data schema to the plurality of controls by associating the controls and the data schema entities while in the development environment.

31. The method of claim 30, further comprising storing metadata representative of a second user interface at the data source, such that access of the data source by a platform results in pushing the metadata to the platform for execution of the second user interface on the platform to view the data source.

32. The method of claim 30, further comprising automatically selecting one of the plurality of controls for use in the development environment based on characteristics of a data string of the data source.

33. The method of claim 30, further comprising automatically adapting the user interface for use with a second data source.

34. The method of claim 30, further comprising structuring presentation of the plurality of controls according to a type of platform on which the user interface is employed.

35. A system that facilitates the creation of a data bound user interface, comprising:
means for generating a plurality of controls in an interface development environment;
means for receiving a data schema that is representative of entities of a data source; and
means for binding the entities of the data schema to the plurality of controls by associating the controls and the entities while in the development environment.

36. The system of claim 35, further comprising:
means for connecting to the data source;
means for managing content of the data source; and
means for associating the entities of the data source with select ones of the plurality of controls.

37. The system of claim 35, further comprising means for visually designing the user interface using graphical representations.

38. The system of claim 35, further comprising means for inputting a parameterized stored procedure on a form of the development environment, in response to which a corresponding parameter entry control and a result control are automatically employed.

39. The system of claim 35, further comprising:
means for selecting multiple objects, which object types include tabular and scalar;
means for associating the multiple objects automatically according to the object type; and
means for editing the user interface to reflect the object type used on a form in the development environment.

40. The system of claim 35, further comprising means for discovering if one of the plurality of controls supports simple or complex data binding.
